(19) United States
(12) Patent Application Publication
(10) Pub. No.: US 2019/0219104 A1
(43) Pub. Date: Jul. 18, 2019

(54) CLUTCH AND FOOD PROCESSOR

(71) Applicant: X.J. ELECTRICS (HUBEI) CO., Ltd., Huanggang (CN)

(72) Inventor: YUN PAN, Huanggang (CN)

(73) Assignee: X.J. ELECTRICS (HUBEI) CO., Ltd.

(21) Appl. No.: 15/870,919

(22) Filed: Jan. 13, 2018

(51) Int. Cl. F16D 11/10; A47J 43/08; A47J 43/10; F16D 11/14; A47J 43/25

(52) U.S. Cl. CPC F16D 11/10; A47J 43/08; F16D 2011/008; F16D 11/14; A47J 43/255; A47J 43/1068

(57) ABSTRACT

A clutch matched with a transmission screw rod comprises a left clutch half tooth, a right clutch half tooth, a clutch screw rod and a clutch base, the left clutch half tooth and the right clutch half tooth can slidably move relative to the clutch base; first threads matched with the transmission screw rod are arranged on the right side face of the left clutch half tooth and the left side face of the right clutch half tooth; the clutch screw rod and the transmission screw rod are located in different planes; a second thread and a third thread in opposite directions are arranged on the clutch screw rod; a fourth thread matched with the second thread and a fifth thread matched with the third thread are separately arranged on the left clutch half tooth and the right clutch half tooth.

The invention relates to the technical field of household electrical appliances, in particular to a clutch and a food processor.

### BACKGROUND OF THE PRESENT INVENTION

A clutch is generally used for separating a power device from an operating element or combining the power device with the operating element; when the clutch between the power device and the operating element is closed, the power device can drive the operating element to move; when the clutch between the power device and the operating element is separated, the operating element can be separated from the power device to move freely.

In certain food processors, the initial position of an operating element, namely a cutter disk, needs to be changed according the length of to-be-processed food, it is required that the operating element can be driven by a motor to move forwards automatically and can also be manually operated by users to advance or retreat in a non-operating state, in this way, the operability and transmission reliability of products are improved, and the market competitiveness of the products is improved. So, in order to achieve the above functions, a clutch needs to be arranged in a food processor. However, although various clutches on the present market can achieve the separation and combination functions, the clutches all have the defects of being complex in structure, difficult to assemble, high in cost, inconvenient to operate and the like.

### SUMMARY OF PRESENT INVENTION

To solve the above technical problems, the invention provides a clutch which is simple in structure and assembly technique, low in cost and convenient to operate, and a food processor provided with the clutch.

According to the first technical scheme adopted by the invention for solving the above technical problems:

a clutch is matched with a transmission screw rod and comprises a left clutch half tooth, a right clutch half tooth, a clutch screw rod and a clutch base, wherein the left clutch half tooth and the right clutch half tooth are both arranged on the clutch base and can slidably move relative to the clutch base, and first threads matched with the transmission screw rod are separately arranged on the right side face of the left clutch half tooth and the left side face of the right clutch half tooth;

the clutch screw rod and the transmission screw rod are located in different planes; a second thread and a third thread are arranged on the clutch screw rod, and the thread direction of the second thread is opposite to the thread direction of the third thread; a fourth thread and a fifth thread are separately arranged on the left clutch half tooth and the right clutch half tooth, the fourth thread is matched with the second thread, and the fifth thread is matched with the third thread.

According to the second technical scheme adopted by the invention for solving the above technical problems:

a food processor comprises the clutch in the first technical scheme and further comprises a driving device, a transmission screw rod and a cutter disk, wherein the driving device drives the transmission screw rod to rotate, the clutch is matched with the transmission screw rod through the first thread, and the cutter disk is fixed to the clutch.

In order to cut food into a complete spiral strip from beginning to end and prevent adhesion of the center parts of cut food and non-cut food, the following technical scheme is further adopted by the invention:

the cutter disk comprises a cutter holder, a slicing cutter and a cylindrical cutter with both ends open, wherein the cylindrical cutter and the slicing cutter are both fixed to the cutter holder, the cylindrical cutter faces the center of a food claw tray, the slicing cutter is arranged on the outer side of the cylindrical cutter, and one end of the slicing cutter is connected with the outer side wall of the cylindrical cutter.

In order to meet the requirements of different customers for cutting food into shreds with different widths, the following technical scheme is further adopted by the invention:

the cutter disk further comprises a toothed cutter, wherein the toothed cutter extends in the radial direction of the cylindrical cutter, and one end of the toothed cutter is connected with the cylindrical cutter. The cutter disk further comprises a toothed cutter, wherein the toothed cutter is fixed to the cutter holder and arranged on the outer side of the cylindrical cutter, and the length direction of the toothed cutter extends in the radial direction of the cylindrical cutter; the toothed cutter comprises a rotatable columnar cutter rest, a first toothed blade, a second toothed blade and a third toothed blade, the columnar cutter rest extends in the radial direction of the cylindrical cutter and comprises four side faces, the first toothed blade, the second toothed blade and the third toothed blade are separately arranged on three side faces of the columnar cutter rest, and the other side face of the columnar cutter rest is a plane.

The invention has the beneficial effects that for the clutch in the invention, the clutch screw rod can be rotated to make the left clutch half tooth and the right clutch half tooth move close to or away from each other, the clutch is closed or separated accordingly, and the clutch screw rod and the transmission screw rod can move without mutual interference; the clutch is ingenious in design, simple in structure and easy to assemble, the cost can be reduced, and the operability is greatly improved; for the food processor in the invention, when the clutch is closed, the cutter disk is locked to the transmission screw rod and can be driven by the driving device to move forwards, and thus food is cut automatically; when the clutch is separated, the cutter disk is separated from the transmission screw rod, a user can move the cutter disk to any position, and thus food with different lengths can be processed extremely conveniently; the cylindrical cutter in the cutter disk in the invention can position the center of food, so that the food is prevented skewing back and forth when cut, and the cutting continuity of the food is ensured; on the other hand, the cylindrical cutter can cut off the middle part of the to-be-cut surface of food, so that a center hole is formed, it is ensured that the food part in contact with the slicing cutter is annular, adhesion of the middle parts of spiral strips obtained through the slicing cutter is prevented, and the whole food is cut into a complete and continuous spiral strip accordingly; food can be cut into complete strips, and the multiple toothed blades with different densities can cut food into shreds with different widths.

### DESCRIPTION OF THE DRAWINGS

FIG. 1 is a structural diagram of a clutch in a first embodiment of the invention (under the condition that the clutch is matched with a transmission screw rod and an upper clutch cover is opened);

FIG. 2 is an exploded view of the clutch in the first embodiment of the invention;

FIG. 3 is an overall structural diagram of a food processor in a second embodiment of the invention;

FIG. 4 is an exploded view of the food processor in the second embodiment of the invention;

FIG. 5 is a sectional view of the food processor in the second embodiment of the invention;

FIG. 6 is an exploded view of a cutter rest assembly in the second embodiment of the invention; and

FIG. 7 is an exploded view of the cutter rest assembly in a third embodiment of the invention;

### DESCRIPTION OF THE MARKS

1, left clutch half tooth; 1-1, first thread; 1-2, second thread; 2, right clutch half tooth; 2-1, third thread; 3, clutch screw rod; 3-1, fourth thread; 3-2, fifth thread; 3-3, stop arm; 4, upper clutch cover; 4-1, limit surface; 5, clutch base; 6, transmission screw rod; 7, connecting rod; 8, rotary knob; 9, motor; 10, gear reducer; 11, multi-stage reduction gear; 12, front cover; 13, rear cover; 14, food claw tray; 15, spiny positioning protrusion; 16, cutter holder; 17, slicing cutter; 18, cylindrical cutter; 19, columnar cutter rest; 20, cutter holder support; 21, main body shell; 22, bottom cover; 23, food; 24, first toothed blade; 25, second toothed blade; 26, third toothed blade; 27, toothed blade substitute; 28, guide block; 29, positioning piece; 30, insertion port; 31, screw cap; 32, connecting rod; 33, first bevel gear, 34, second bevel gear; 35, shaping blade.

### DETAILED DESCRIPTION OF PREFERRED EMBODIMENTS

A detailed description of the technical content, purposes and effects of the invention is given with embodiments and accompanying drawings as follows.

The key conception of the invention lies in that a left clutch half tooth 1 and a right clutch half tooth 2 are arranged, and first threads 1-1 matched with a transmission screw rod 6 are arranged on the right side face of the left clutch half tooth 1 and the left side face of the right clutch half tooth 2; furthermore, a fourth thread 3-1 and a fifth thread 3-2 which are in opposite directions are arranged on the left clutch half tooth 1 and the right clutch half tooth 2 and matched with a clutch screw rod 3; when the clutch screw rod 3 rotates, the left clutch half tooth 1 and the right clutch half tooth 2 can simultaneously move close to or away from the transmission screw rods 6, and thus the separation and combination functions are achieved.

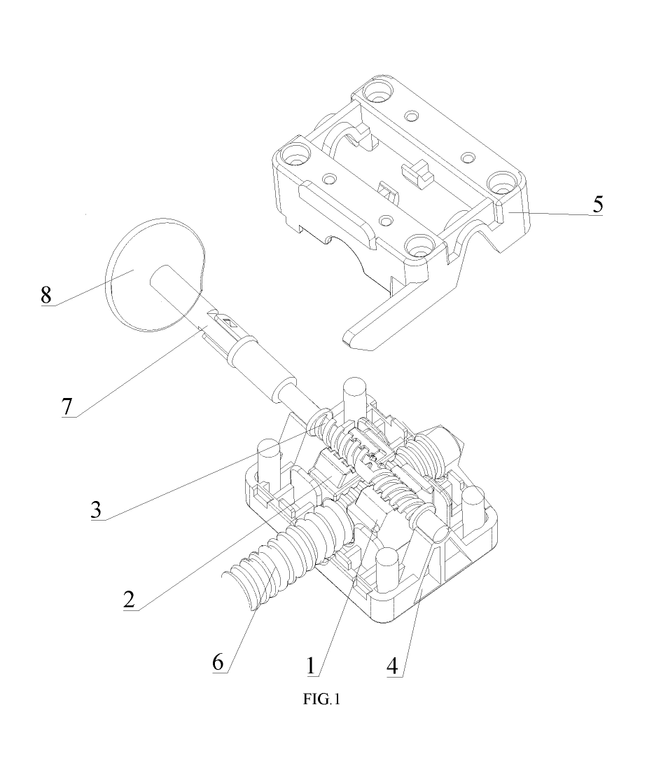

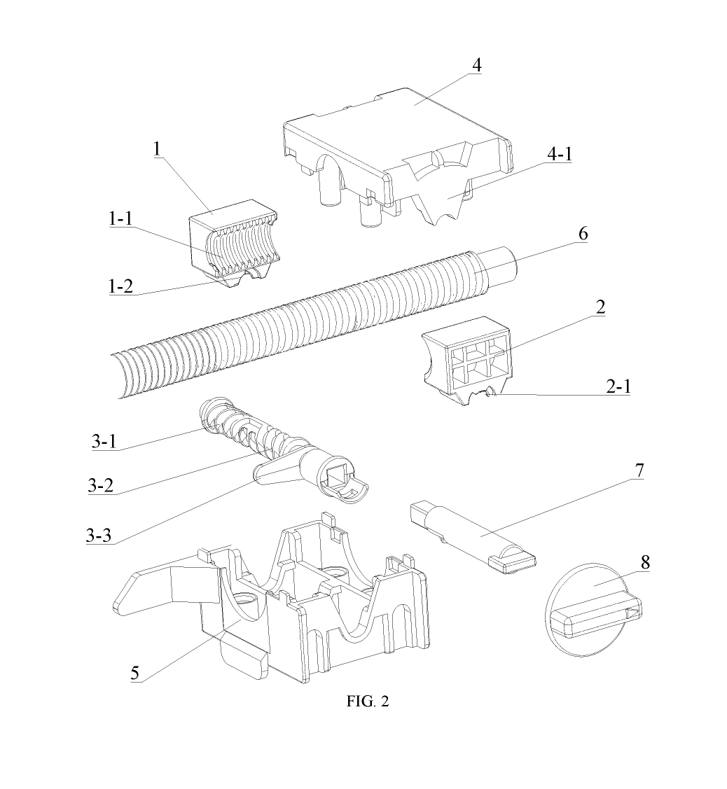

As is shown in FIG. 1 and FIG. 2, a clutch is matched with a transmission screw rod 6 and comprises a left clutch half tooth 1, a right clutch half tooth 2, a clutch screw rod 3 and a clutch base 5, wherein the left clutch half tooth 1 and the right clutch half tooth 2 are both arranged on the clutch base 5 and can slidably move relative to the clutch base 5; first threads 1-1 matched with the transmission screw rod 6 are separately arranged on the right side face of the left clutch half tooth 1 and the left side face of the right clutch half tooth 2;

the clutch screw rod 3 and the transmission screw rod 6 are located in different planes; a second thread 1-2 and a third thread 2-1 are arranged on the clutch screw rod 3, and the thread direction of the second thread 1-2 is opposite to the thread direction of the third thread 2-1; a fourth thread 3-1 and a fifth thread 3-2 are separately arranged on the left clutch half tooth 1 and the right clutch half tooth 2, the fourth thread 3-1 is matched with the second thread 1-2, and the fifth thread 3-2 is matched with the third thread 2-1.

From the above description, the clutch of the invention has the beneficial effects that the clutch screw rod of the clutch can be rotated to make the left clutch half tooth and the right clutch half tooth move close to or away from each other, and thus the clutch is closed or separated; the clutch screw rod and the transmission screw rod are located in different planes and thus can move without mutual interference; the clutch is ingenious in design, simple in structure and easy to assemble, the cost can be reduced, and the operability is greatly improved.

Furthermore, the clutch comprises a clutch handle, and the clutch handle is connected to the clutch screw rod 3.

From the above description, the clutch screw rod can be conveniently operated to rotate through the clutch handle.

Furthermore, the clutch comprises an upper clutch cover, and the left clutch half tooth 1 and the right clutch half tooth 2 are clamped between the upper clutch cover 4 and the clutch base 5.

From the above description, the upper clutch cover and the clutch base can restrain circumferential movement of the left clutch half tooth and the right clutch half tooth, and thus the left clutch half tooth and the right clutch half tooth can move only in the axial direction.

Furthermore, the upper clutch cover 4 or the clutch base 5 is provided with a limit surface 4-1 protruding outwards, a stop arm 3-3 is arranged at the position, corresponding to the limit surface 4-1, of the clutch screw rod 3 and extends in the direction perpendicular to the axial direction of the clutch screw rod 3, and a protruding limit block is arranged at the tail end of the stop arm 3-3.

From the above description, when the clutch screw rod rotates to extreme positions on the two sides (namely the locking position and the separation position), the limit block on the stop arm exactly right can stride across the two side edges of the limit surface, and thus an operator can judge the rotating condition of the clutch according to the hand feeling, and the experience effect is better.

Furthermore, the fourth thread 3-1 and the fifth thread 3-2 are single-start threads or multi-start threads.

From the above description, the left clutch half tooth and the right clutch half tooth can be matched with the clutch screw rod through single-start threads or multi-start threads; when the left clutch half tooth and the right clutch half tooth are matched with the clutch screw rod through multi-start threads, the friction force between the left clutch half tooth and the clutch screw rod as well as between the right clutch half tooth and the clutch screw rod can be further increased, the clutch screw rod is prevented from rotating reversely, and a self-locking function of the clutch is achieved.

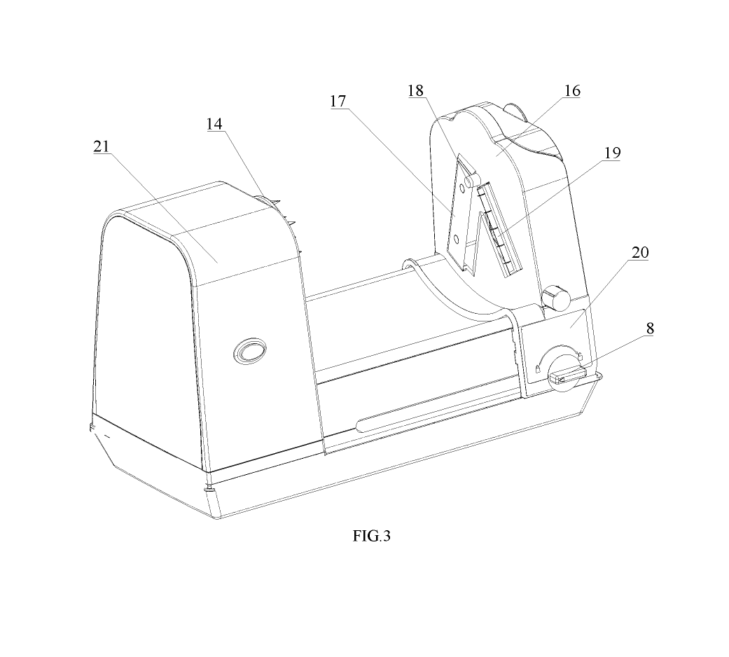

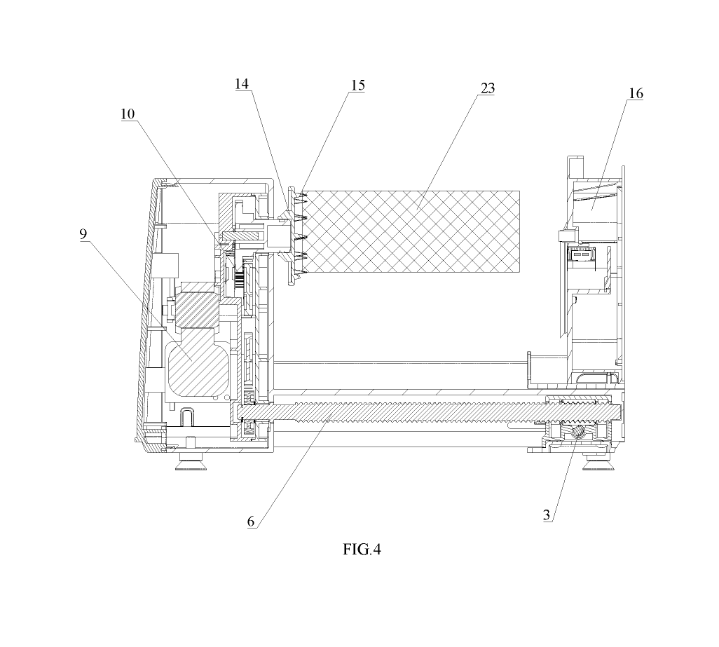

Please see FIGS. 3-5, a food processor comprises the clutch mentioned above and further comprises a driving device, a transmission screw rod 6 and a cutter disk, wherein the driving device drives the transmission screw rod 6 to rotate, the clutch is matched with the transmission screw rod 6 through the first thread 1-1, and the cutter disk is fixed to the clutch.

From the above description, as for the food processor in the invention, when the clutch is closed, the cutter disk is locked to the transmission screw rod and can be driven by the driving device to move forwards, and thus food is cut automatically; when the clutch is separated, the cutter disk is separated from the transmission screw rod, a user can move the cutter disk to any position, and thus food with different lengths can be processed extremely conveniently.

Furthermore, the food processor comprises a food claw tray 14, and the food claw tray 14 is driven by the driving device to rotate and provided with a plurality of spiny positioning protrusions 15.

From the above description, food such as a radish can be directly inserted onto the spiny positioning protrusions by the user with hands so as to be positioned, the food can be driven by the food claw tray to rotate, the cutter disk is connected to the transmission screw rod through the clutch and moves in the axial direction, and thus the rotating food can be cut; in addition, the spiny positioning protrusions have a low requirement for the surface regularity of food, and thus food in irregular shapes can also be easily positioned on the food claw tray.

Furthermore, the cutter disk comprises a slicing cutter 17 and a cylindrical cutter 18, the cylindrical cutter 18 faces the center of the food claw tray 14, the slicing cutter 17 extends in the radial direction of the cylindrical cutter 18, and one end of the slicing cutter 17 is connected with the cylindrical cutter 18.

From the above description, as an existing food processor is only provided with one blade, food can only be cut into discontinuous segments instead of being cut into a complete strip when cut by the existing food processor, and the requirements of existing customers cannot be met; however, in the invention, the small-diameter cylindrical cutter is arranged at the cutting center of the cutter disk, the slicing cutter is connected with the cylindrical cutter, when food is cut, the cylindrical cutter cuts off the center of the food, so that a center hole is formed, the slicing cutter conducts cutting along the center hole, and accordingly the rotating food can be cut into a continuous strip.

Furthermore, the cutter disk comprises a cutter holder 16, a slicing cutter 17 and a cylindrical cutter 18 with both ends open, wherein the cylindrical cutter 18 and the slicing cutter 17 are both fixed to the cutter holder 16, the cylindrical cutter 18 faces the center of the food claw tray 14, the slicing cutter 17 is arranged on the outer side of the cylindrical cutter 18, and one end of the slicing cutter 17 is connected with the outer side wall of the cylindrical cutter 18.

From the above description, when a cutter rest assembly in the invention is used for cutting rotating food or the cutter rest assembly in the invention rotates to cut fixed food, on the one hand, the cylindrical cutter can position the center of the food, so that the food is prevented from skewing back and forth when cut, and the cutting continuity of the food is ensured; on the other hand, the cylindrical cutter can cuts off the center part of the food for forming the center hole, so that it is ensured that the food part in contact with the slicing cutter is annular, adhesion of the middle parts of spiral strips obtained through the slicing cutter is avoided, and the whole food is cut into a complete and continuous spiral strip accordingly; food can be cut into complete strips.

Furthermore, the cutter disk comprises a toothed cutter, wherein the toothed cutter is fixed to the cutter holder 16 and arranged on the outer side of the cylindrical cutter 18, and the length direction of the toothed cutter extends in the radial direction of the cylindrical cutter 18.

From the above description, the slicing cutter can cut food into wide strips, the additionally-arranged toothed cutter can scratch the to-be-cut surface of the food, so that multiple deep marks are formed on the to-be-cut surface of the food, and then the to-be-cut surface is cut into a plurality of narrow shreds through the slicing cutter.

Furthermore, the tip of the toothed cutter protrudes out of the plane where the slicing cutter 17 is located.

From the above description, as the tip of the toothed cutter is higher than the slicing cutter, it can be ensured that the food always makes contact with the toothed cutter firstly and then makes contact with the slicing cutter before being cut, and the food can be divided into shreds from beginning to end.

Furthermore, the toothed cutter comprises a rotatable columnar cutter rest 19, a first toothed blade 24, a second toothed blade 25 and a third toothed blade 26, wherein the columnar cutter rest 19 extends in the radial direction of the cylindrical cutter 18 and comprises four side faces, the first toothed blade 24, the second toothed blade 25 and the third toothed blade 26 are arranged on three side faces of the columnar cutter rest 19 separately, and the other side face of the columnar cutter rest 19 is a plane.

From the above description, when the first toothed blade, the second toothed blade and the third toothed blade rotate to the front side of the cutter holder respectively, the cutter rest assembly can separately cut food into three types of shreds with different widths; when the planar side of the columnar cutter rest rotates to the front side of the cutter holder, only the slicing cutter works, and the cutter rest assembly can cut food into slices.

Furthermore, the food processor comprises a cutter holder support 20, wherein the cutter holder 16 is arranged on the cutter holder support 20, and the cutter holder support 20 is connected to the clutch; the cutter holder 16 is provided with a positioning hole, the cutter holder support is provided with a protruding positioning piece 29, the positioning piece 29 is inserted into the positioning hole, and the end of the positioning piece 29 abuts against the columnar cutter rest 19.

From the above description, after the toothed blade with the required density is rotated to the front side of the cutter holder, the cutter holder and the cutter holder support can be fixed together, meanwhile, the protruding positioning piece on the cutter holder support is inserted into the positioning hole in the cutter holder, then the positioning piece can abut against the columnar cutter rest, and thus the columnar cutter rest is prevented from rotating in the working process.

Furthermore, the food processor comprises a rotating assembly, and the rotating assembly is connected to the columnar cutter rest 19.

From the above description, the user can conveniently operate the columnar cutter rest through the rotating assembly.

Furthermore, the rotating assembly comprises a screw cap 31, a connecting rod 32, a first bevel gear 33 and a second bevel gear 34, wherein the screw cap 31 is connected to the first bevel gear 33 through the connecting rod 32, the second bevel gear 34 is connected to the columnar cutter rest 19, and the first bevel gear 33 is engaged with the second bevel gear 34.

Furthermore, the food processor comprises a shaping blade 35, wherein the shaping blade 35 is arranged at the outlet end of the cylindrical cutter 18, and the cutting edge of the shaping blade 35 is perpendicular to the axial direction of the cylindrical cutter 18.

From the above description, the cylindrical cutter can cut out the center of food, so that a cylindrical food part is formed, and the cylindrical food part also rotates along with the to-be-cut food; the shaping blade is arranged at the outlet end of the cylindrical cutter, and thus the cylindrical food part discharged out of the cylindrical cutter can also be cut into a whole spiral shred.

Furthermore, the food processor comprises a guide block 28, wherein the guide block 28 is arranged on the back side of the cutter holder 16, is adjacent to the outer side face of the cylindrical cutter 18 and comprises a spiral surface, and the spiral surface extends in the direction away from the cutter holder 16.

From the above description, the spiral surface of the guide block can convey spiral food discharged out of the slicing cutter away from the cutter holder, and thus the situation that food accumulates and consequentially is broken when touching the cutter holder is avoided; the guide block can also prevent the food discharged out of the slicing cutter from touching food discharged out of the cylindrical cutter, and thus mutual interference between the food discharged out of the slicing cutter and the food discharged out of the cylindrical cutter is avoided.

Furthermore, a spiral guide rib is arranged at the position, corresponding to the slicing cutter 17, of the top of the cutter holder 16.

From the above description, the spiral guide rib can guide spiral strips discharged out of the slicing cutter, and the situation that the spiral strips directly abut against the top of the cutter holder and consequentially are broken is avoided.

Furthermore, the food processor comprises a toothed blade substitute 27, the cutter holder 16 is provided with an insertion port 30, and the toothed blade substitute 27 is inserted into the insertion port 30.

From the above description, different toothed blades can be adopted through substitutes.

Furthermore, the toothed blade substitute 27 is in interference fit with the insertion port 30 or is matched with the insertion port 30 through a buckle.

Furthermore, the driving device comprises a gear reducer 10, wherein the gear reducer 10 comprises an input wheel, a first output wheel and a second output wheel, the input wheel is connected to the power output end of a motor 9, the first output wheel is connected to the food claw tray 14, and the second output wheel is connected to the transmission screw rod 6.

From the above description, the driving device can provide two outputs through the gear reducer, one output is used for driving the food claw tray, and the other output is used for driving the screw rod to rotate, so that the cutter rest assembly is driven to move.

### First Embodiment

As is shown in FIG. 1 and FIG. 2, the first embodiment of the invention provides a clutch which is matched with a transmission screw rod 6, driven by the transmission screw rod 6 and used for connecting other elements or assemblies to the transmission screw rod 6 and can separate the element or the assembly from the transmission screw rod 6 or combine the element or the assembly with the transmission screw rod 6.

The clutch comprises a left clutch half tooth 1, a right clutch half tooth 2, a clutch screw rod 3 and a clutch case, wherein the left clutch half tooth 1 and the right clutch half tooth 2 are separately arranged on the left side and the right side in the clutch case; the clutch case comprises an upper clutch cover 4 and a clutch base 5, the upper clutch cover 4 and the clutch base 5 are connected through screws, and the left clutch half tooth 1 and the right clutch half tooth 2 are clamped between the upper clutch cover 4 and the clutch base 5. Optionally, the left clutch half tooth 1 and the right clutch half tooth 2 can also be connected to the clutch base 5 through sliding rails, thereby being capable of moving relative to the clutch base 5. First threads 1-1 matched with the transmission screw rod 6 are separately arranged on the right side face of the left clutch half tooth 1 and the left side face of the right clutch half tooth 2.

The clutch screw rod 3 and the transmission screw rod 6 are located in different planes, and in the embodiment, the clutch screw rod 3 is arranged below the transmission screw rod 6 and is perpendicular to the transmission screw rod 6. A second thread 1-2 and a third thread 2-1 are arranged on the clutch screw rod 3, and the thread direction of the second thread 1-2 is opposite to the thread direction of the third thread 2-1; a fourth thread 3-1 and a fifth thread 3-2 are separately arranged on the left clutch half tooth 1 and the right clutch half tooth 2, the fourth thread 3-1 is matched with the second thread 1-2, and the fifth thread 3-2 is matched with the third thread 2-1. Preferably, the fourth thread 3-1 and the fifth thread 3-2 are single-start threads or multi-start threads.

Furthermore, the clutch comprises a clutch handle, and one end of the clutch handle is clamped on the clutch screw rod 3. In the embodiment, the clutch handle comprises a connecting rod 7 and a rotary knob 8, wherein one end of the connecting rod 7 is clamped on the clutch screw rod 3, and the other end of the connecting rod 7 is clamped on the rotary knob 8. Of course, the clutch handle can also be formed integrally. A user can operate the clutch screw rod 3 to rotate through the rotary knob 8.

Furthermore, the upper clutch cover 4 or the clutch base 5 is provided with a limit surface 4-1 protruding outwards, a stop arm 3-3 is arranged at the position, corresponding to the limit surface 4-1, of the clutch screw rod 3 and extends in the direction perpendicular to the axial direction of the clutch screw rod 3, and a protruding limit block is arranged at the tail end of the stop arm 3-3. When the clutch screw rod 3 rotates to extreme positions on the two sides, the limit block can stride across the two side edges of the limit surface 4-1, and sounds are made so that the user can judge whether the clutch screw rod 3 rotates in position or not through the hand feeling or sounds.

### Second Embodiment

As is shown in FIGS. 3-5, the embodiment of the invention provides a food processor which can cut radishes, potatoes or other food into continuous strips or shreds with different widths. The food processor comprises the clutch in the first embodiment and further comprises a driving device, a transmission screw rod 6, a cutter disk and a food claw tray 14, wherein the driving device drives the transmission screw rod 6 and the food claw tray 14 to rotate, the clutch is matched with the transmission screw rod 6 through the first thread 1-1, and the cutter disk is fixed to the clutch case.

The driving device comprises a motor 9 and a gear reducer 10, wherein the gear reducer 10 comprises a multi-stage reduction gear 11, a front cover 12 and a rear cover 13, and the multi-stage reduction gear 11 is arranged in a shell formed by the front cover 12 and the rear cover 13. The gear reducer 10 is driven by the motor 9 and comprises a first output wheel and a second output wheel, the first output wheel drives the food claw tray 14 to rotate, and the second output wheel drives the transmission screw rod 6 to rotate.

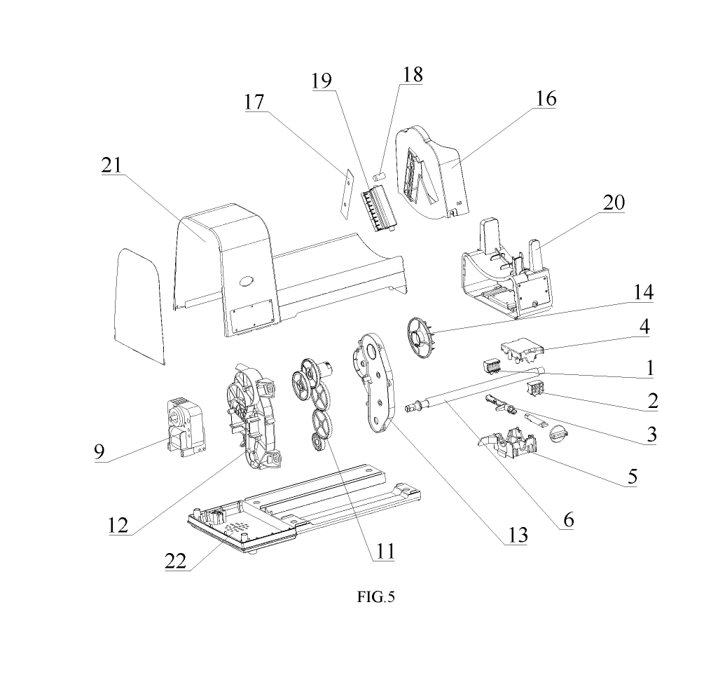

As is shown in FIG. 5, the food claw tray 14 is provided with a plurality of spiny positioning protrusions 15, and food 23 can be directly inserted onto the spiny positioning protrusions 15 by the user so as to be positioned rapidly.

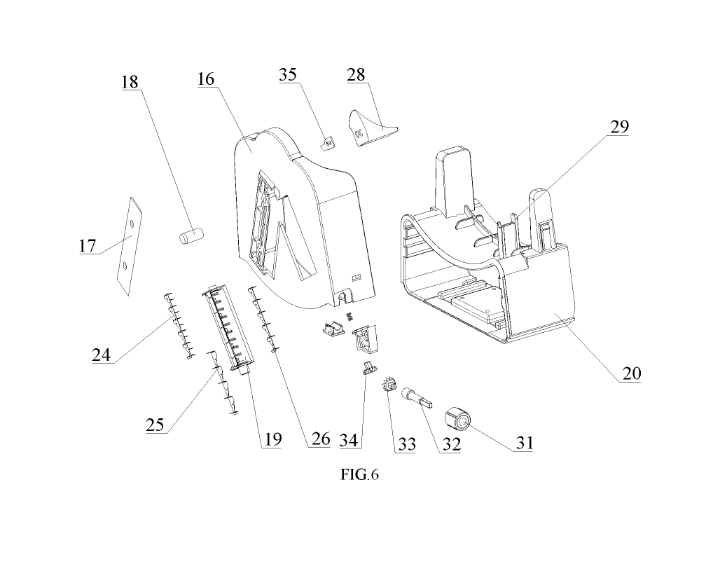

As is shown in FIG. 6, the cutter disk comprises a cutter holder 16, a cylindrical cutter 18 with both ends open, a slicing cutter 17 and a toothed cutter, and mounting sites for the cylindrical cutter 18, the slicing cutter 17 and the toothed cutter are all located on the cutter holder 16. The cylindrical cutter 18, the slicing cutter 17 and the toothed cutter are all fixed to the cutter holder 16; the length direction of the cylindrical cutter 18 is perpendicular to the cutter holder 16, and the front end and the rear end of the cylindrical cutter 18 penetrate through the cutter holder 16. The slicing cutter 17 is arranged on the outer side of the cylindrical cutter 18, and one end of the slicing cutter 17 is connected with the outer side wall of the cylindrical cutter 18. The toothed cutter is arranged on the outer side of the cylindrical cutter 18, and the length direction of the toothed cutter extends in the radial direction of the cylindrical cutter 18. The toothed cutter comprises a plurality of upright sharp teeth, and the tip of the toothed cutter protrudes out of the plane where the slicing cutter 17 is located.

The toothed cutter comprises a rotatable columnar cutter rest 19 and a plurality of toothed blades with different densities, wherein the multiple toothed blades with different densities are arranged on the outer side faces of the columnar cutter rest 19 at intervals, and the length directions of the multiple toothed blades with different densities are all consistent with the length direction of the columnar cutter rest 19. In the embodiment, the toothed cutter comprises a rotatable columnar cutter rest 19, a first toothed blade 24, a second toothed blade 25 and a third toothed blade 26, wherein the sharp tooth densities of the first toothed blade 24, the second toothed blade 25 and the third toothed blade 26 are different; the columnar cutter rest 19 is in the shape of a square column and comprises four side faces, and the first toothed blade 24, the second toothed blade 25 and the third toothed blade 26 are separately arranged on three side faces of the columnar cutter rest 19, and the other side face of the columnar cutter rest 19 is s plane. The columnar cutter rest 19 rotates on the cutter holder 16 so that toothed blades with different densities can face the front side of the cutter holder 16 and be matched with the slicing cutter 17 on the front side of the cutter holder 16 for food cutting.

Preferably, the columnar cutter rest 19 is connected to a rotating assembly. The rotating assembly comprises a screw cap 31, a connecting rod 32, a first bevel gear 33 and a second bevel gear 34, wherein the screw cap 31 is connected to the first bevel gear 33 through the connecting rod 32, the second bevel gear 34 is connected to the columnar cutter rest 19, and the first bevel gear 33 is engaged with the second bevel gear 34. The user can rotate the columnar cutter rest 19 by operating the screw cap 31, and thus the toothed blade with the required density is selected.

A guide block 28 is further arranged on the back side of the cutter holder 16 and comprises a spiral surface, and the spiral surface extends in the direction away from the cutter holder 16. As the guide block 28 is adjacent to the outer side face of the cylindrical cutter 18, on the one hand, the guide block 28 can convey spiral food slices discharged out of the slicing cutter 17 away from the cutter holder 16, and thus the situation that the food slices accumulate and consequentially are broken when touching the cutter holder 16 is avoided; on the other hand, the guide block 28 can prevent the spiral food slices from making contact with columnar food in the cylindrical cutter 18. Furthermore, a spiral guide rib is arranged at the position, corresponding to the slicing cutter 17, of the top of the cutter holder 16.

Food can be discharged from the back side of the cutter holder 16 after being cut on the front side of the cutter holder 16, and a small cylinder is discharged from the rear end of the cylindrical cutter 18. Preferably, a shaping blade 35 is arranged on the back side of the cutter holder 16 and located at the outlet end of the cylindrical cutter 18, the length direction of the shaping blade 35 is perpendicular to the axial direction of the cylindrical cutter 18, and the tip of the shaping blade 35 overlaps with the axis of the cylindrical cutter 18 so that the cylinder discharged out of the cylindrical cutter 18 can also be cut into a spiral shred.

The cutter holder 16 assembly further comprises a cutter holder support 20, and the cutter holder 16 is arranged on the cutter holder support 20 and matched with the cutter holder support 20 through an elastic buckle 12. The cutter holder 16 is provided with a positioning hole, the cutter holder support 20 is provided with a protruding positioning piece 29, the positioning piece 29 is inserted into the positioning hole, and the end of the positioning piece 29 abuts against the columnar cutter rest 19.

Preferably, the food processor further comprises a main body shell 21, the cutter holder support 20, a bottom cover 22 and a cutter disk cover 23, wherein the bottom of the main body shell 21 is covered with the bottom cover 22, the driving device, the transmission screw rod 6 and the clutch are all arranged in the main body shell, and the food claw tray 14 and the cutter disk are located outside the main body shell 21. The cutter holder support 20 is connected to the clutch, the cutter holder is connected with the cutter holder support through a buckle, and the cutter disk can be independently dismounted to be cleaned after being used by the user. The cutter disk cover 23 is arranged on the back side of the cutter disk.

### Third Embodiment

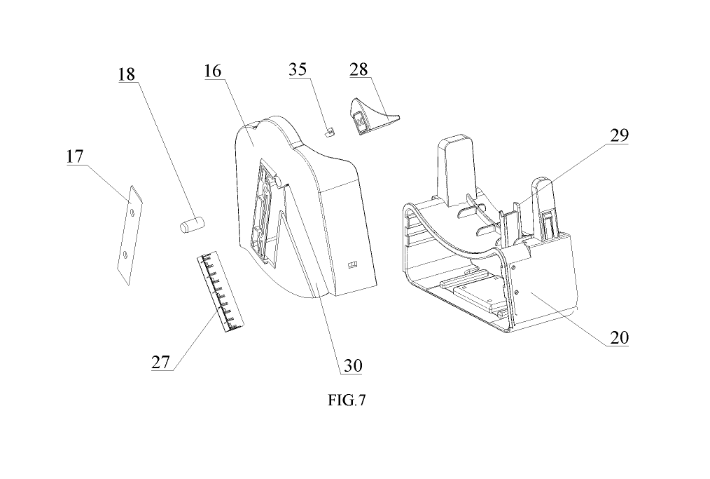

As is shown in FIG. 7, the third embodiment is different from the second embodiment in that the cutter disk comprises a plurality of insert-type toothed blade substitutes 27, an insertion port 30 is arranged on the cutter holder 16 and located on the outer side of the cylindrical cutter 18, and the length direction of the insertion port 30 is consistent with the radial direction of the cylindrical cutter 18. One toothed blade substitute 27 is inserted into the insertion port 30 and is in interference fit with the insertion port 30 or is matched with the insertion port 30 through a buckle.

When the user needs a different toothed blade, the existing toothed blade substitute 27 on the cutter holder 16 is pulled down, and then another toothed blade substitute 27 is inserted into the insertion port 30. The toothed blades in the form are convenient to clean.

In conclusion, the clutch and the food processor provided by the invention are ingenious in design, simple in structure and assembly technique, and high in operability; the cutter holder can be locked to the transmission screw rod 6 so as to move automatically and can also be separated from the transmission screw rod 6 so as to be manually moved to any required position by the user; the food processor of the invention can cut food into continuous strips, and multiple different toothed blades can also be freely selected to cut food into shreds with different widths or different thicknesses.

The above description only refers to embodiments of the invention, however, the patent scope of the invention is not limited to the embodiments mentioned above, and all equivalent transformations made according to the content in the description and the drawings of the invention or direct/indirect applications to relevant technical fields are within the patent protection scope of the invention.

I claim:

1. A clutch, matched with a transmission screw rod, wherein the clutch comprises a left clutch half tooth, a right clutch half tooth, a clutch screw rod and a clutch base, wherein the left clutch half tooth and the right clutch half tooth are both arranged on the clutch base and can slidably move relative to the clutch base, and first threads matched with the transmission screw rod are separately arranged on the right side face of the left clutch half tooth and the left side face of the right clutch half tooth;
the clutch screw rod and the transmission screw rod are located in different planes; a second thread and a third thread are arranged on the clutch screw rod, and the thread direction of the second thread is opposite to the thread direction of the third thread; a fourth thread and a fifth thread are separately arranged on the left clutch half tooth and the right clutch half tooth, the fourth thread is matched with the second thread, and the fifth thread is matched with the third thread.

2. The clutch according to claim 1, wherein the clutch further comprises a clutch handle, wherein the clutch handle is connected to the clutch screw rod.

3. The clutch according to claim 1, wherein the clutch further comprises an upper clutch cover, wherein the left clutch half tooth and the right clutch half tooth are clamped between the upper clutch cover and the clutch base.

4. The clutch according to claim 3, wherein the upper clutch cover or the clutch base is provided with a limit surface protruding outwards, a stop arm is arranged at the position, corresponding to the limit surface, of the clutch screw rod and extends in the direction perpendicular to the axial direction of the clutch screw rod, and a protruding limit block is arranged at the tail end of the stop arm.

5. The clutch according to claim 1, wherein the fourth thread and the fifth thread are single-start threads or multi-start threads.

6. A food processor, wherein the food processor further comprises the clutch in claim 1 and further comprises a driving device, a transmission screw rod and a cutter disk, the driving device drives the transmission screw rod to rotate, the clutch is matched with the transmission screw rod through the first thread, and the cutter disk is fixed to the clutch.

7. The food processor according to claim 6, wherein the food processor further comprises a food claw tray, wherein the food claw tray is driven by the driving device to rotate and provided with a plurality of spiny positioning protrusions.

8. The food processor according to claim 7, wherein the cutter disk comprises a cutter holder, a slicing cutter and a cylindrical cutter with both ends open, the cylindrical cutter and the slicing cutter are both fixed to the cutter holder, the cylindrical cutter faces the center of the food claw tray, the slicing cutter is arranged on the outer side of the cylindrical cutter, and one end of the slicing cutter is connected with the outer side wall of the cylindrical cutter.

9. The food processor according to claim 8, wherein the cutter disk further comprises a toothed cutter which extends in the radial direction of the cylindrical cutter, and one end of the toothed cutter is connected with the cylindrical cutter; the cutter disk further comprises a toothed cutter which is fixed to the cutter holder and arranged on the outer side of the cylindrical cutter, and the length direction of the toothed cutter extends in the radial direction of the cylindrical cutter.

10. The food processor according to claim 9, wherein the tip of the toothed cutter protrudes out of the plane where the slicing cutter is located.

11. The food processor according to claim 9, wherein the toothed cutter comprises a rotatable columnar cutter rest, a first toothed blade, a second toothed blade and a third toothed blade, wherein the columnar cutter rest extends in the radial direction of the cylindrical cutter and comprises four side faces, the first toothed blade, the second toothed blade and a third toothed blade are arranged on three side faces of the columnar cutter rest, and the other side face of the columnar cutter rest is a plane.

12. The food processor according to claim 11, wherein the food processor further comprises a cutter holder support, wherein the cutter holder is arranged on the cutter holder support, and the cutter holder support is connected to the clutch; the cutter holder is provided with a positioning hole, the cutter holder support is provided with a protruding positioning piece, the positioning piece is inserted into the positioning hole, and the end of the positioning piece abuts against the columnar cutter rest.

13. The food processor according to claim 11, wherein the food processor further comprises a rotating assembly, wherein the rotating assembly is connected to the columnar cutter rest.

14. The food processor according to claim 13, wherein the rotating assembly comprises a screw cap, a connecting rod, a first bevel gear and a second bevel gear, wherein the screw cap is connected to the first bevel gear through the connecting rod, the second bevel gear is connected to the columnar cutter rest, and the first bevel gear is engaged with the second bevel gear.

15. The food processor according to claim 8, wherein the food processor further comprises a shaping blade, wherein the shaping blade is arranged at the outlet end of the cylindrical cutter, and the cutting edge of the shaping blade is perpendicular to the axial direction of the cylindrical cutter.

16. The food processor according to claim 8, wherein the food processor further comprises a guide block, wherein the guide block is arranged on the back side of the cutter holder and is adjacent to the outer side face of the cylindrical cutter, and the guide block comprises a spiral surface which extends in the direction away from the cutter holder.

17. The food processor according to claim 8, wherein a guide rib is further arranged at the position, corresponding to the slicing cutter, of the top of the cutter holder.

18. The food processor according to claim 8, wherein the food processor further comprises a toothed blade substitute, wherein the cutter holder is provided with an insertion port, and the toothed blade substitute is inserted into the insertion port.

19. The food processor according to claim 18, wherein the toothed blade substitute is in interference fit with the insertion port or is matched with the insertion port through a buckle.

20. The food processor according to claim 6, wherein the driving device further comprises a gear reducer, the gear reducer comprises an input wheel, a first output wheel and a second output wheel, the input wheel is connected to the power output end of the motor, the first output wheel is connected to the food claw tray, and the second output wheel is connected to the transmission screw rod.
